(19) United States
(12) Patent Application Publication
(10) Pub. No.: US 2025/0086576 A1
(43) Pub. Date: Mar. 13, 2025

(54) ROUTE OPTIMIZATION FOR PRODUCT SHIPMENT IN A SUPPLY CHAIN

(71) Applicant: HONEYWELL INTERNATIONAL INC., Charlotte, NC (US)

(72) Inventors: Varun Singh, Pune (IN); Kartikeyan Bollapalli, Bangalore (IN)

(21) Appl. No.: 18/367,475

(22) Filed: Sep. 13, 2023

(51) Int. Cl. G06Q 10/0835; G06Q 10/083; G06Q 10/0875

(52) U.S. Cl. CPC G06Q 10/08355; G06Q 10/0838; G06Q 10/0875

(57) ABSTRACT

Techniques for logistics management in a supply chain are described. In one aspect, a first data including a first location and a second location associated with a shipment mix to be transported amongst a plurality of facilities located at different locations is obtained. Further, a second data associated with a product amongst the plurality of products is acquired, where the second data includes a hierarchical information and a historical path information of the product. A derived inventory of the plurality of products available within each facility is computed in correspondence with the second data associated with the product. The derived inventory of each facility is compared with an actual inventory of each facility to generate a reconciled output. The reconciled output is analyzed along with the second data acquired to generate feasible path layouts, from which a recommended path is selected for transporting the shipment mix.

### TECHNICAL FIELD

The present subject matter relates, in general, to logistics management in a supply chain, and in particular, to route optimization for product shipment in the supply chain.

### BACKGROUND

Typically, products in a supply chain travel through various facilities of the supply chain such as suppliers, manufacturers, warehouses, distributors, and the like. A product traveling from a source location to an assigned destination across facilities of the supply chain, for example, from a supplier to a consumer, or within a facility of the supply chain, for example, from one department to another department of the facility, is subjected to various processes in the supply chain. Processes such as commissioning, packing, shipping, decommissioning, and the like are performed for various products of the supply chain. The movement of the products being shipped across the supply chain are monitored and tracked. Generally, tracking systems are employed in facilities of the supply chain to record the movement of various products subjected to the various processes in the supply chain.

### SUMMARY

Aspects of the present subject matter provide techniques for optimizing logistics management in a supply chain network.

According to an example of the present subject matter, a method for logistics management in a supply chain is provided. The method includes obtaining a first data which includes a first location and a second location associated with a shipment mix to be transported amongst a plurality of facilities located at different locations that form a part of the supply chain, where the shipment mix comprises a plurality of products. A second data associated with a product amongst the plurality of products is acquired, where the second data includes a hierarchical information of the product and a historical path information of the product. In correspondence to the second data acquired, a derived inventory of the plurality of products available within each facility amongst the plurality of facilities is computed. The derived inventory of each facility is then compared with an actual inventory of each facility to generate a reconciled output, where the actual inventory of each facility is obtained from an inventory database corresponding to each facility, and where the reconciled output is indicative of discrepancy in the inventory and path in which the discrepancy has occurred of the shipment mix. Further, the reconciled output along with the second data acquired are analyzed to generate feasible path layouts and a recommended path from the feasible path layouts generated is selected for transporting the shipment mix.

According to another example of the present subject matter, a system for logistics management is provided. The system includes an input module, an analyzing module, and a route optimizing module. The input module is to obtain a first data including a first location and a second location associated with a shipment mix to be transported amongst a plurality of facilities located at different locations that form a part of the supply chain, where the shipment mix includes a plurality of products. Further, a second data associated with the product amongst the plurality of products is acquired by the input module, where the second data includes a hierarchical information of the product and a historical path information of the product. The analyzing module is to compute a derived inventory of the plurality of products available within each facility amongst the plurality of facilities based on the second data associated with the product. The analyzing module is to compare the derived inventory of each facility with an actual inventory of each facility to generate a reconciled output, where the actual inventory of each facility is obtained from an inventory database corresponding to each facility, and where the reconciled output is indicative of a current status of the product. Further, the analyzing module is to analyze the reconciled output along with the second data acquired associated with the product to generate feasible path layouts. The route optimizing module is to select a recommended path from the feasible path layouts generated for transporting the shipment mix in correspondence to the current status of the product.

According to another example of the present subject matter, a non-transitory computer readable medium containing program instruction is provided, that, when executed, causes the processor to obtain a location data which includes a source location and an assigned destination associated with a shipment mix to be transported in a supply chain, wherein the shipment mix comprises a plurality of products, obtain a second data associated with the product amongst the plurality of products based on a unique identifier ID assigned to the product, scan the unique ID to compute a derived inventory of the plurality of products available within each facility amongst the plurality of facilities, compare the derived inventory of each facility with an actual inventory of each facility to generate a reconciled output, where the actual inventory of each facility is obtained from an inventory database corresponding to each facility, and the reconciled output is indicative of discrepancy in the inventory and path in which the discrepancy has occurred of the shipment mix, analyze the reconciled output along with the second data acquired form the product to generate feasible path layouts, and select a recommended path from the feasible path layouts generated for transporting the shipment mix.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a supply chain network environment, in accordance with an example implementation of the present subject matter.

FIG. 2 illustrates an example supply chain network, in accordance with an example implementation of the present subject matter.

FIG. 3 illustrates another example supply chain network, in accordance with an example implantation of the present subject matter.

FIG. 4 illustrates hierarchical information associated with a product, in accordance with an example implementation of the present subject matter.

FIG. 5 illustrates a logistics management system, in accordance with an example implementation of the present subject matter.

FIG. 6 illustrates an example of route optimization, in accordance with an example implementation of the present subject matter.

FIG. 7 illustrates another example of route optimization, in accordance with an example implementation of the present subject matter.

FIG. 8 illustrates a method for logistics management, in accordance with an example implementation of the present subject matter.

FIG. 9 illustrates another example method for logistics management, in accordance with an example implementation of the present subject matter.

FIG. 10 illustrates a non-transitory computer-readable medium for logistics management of a supply chain, in accordance with an example implementation of the present subject matter.

### DETAILED DESCRIPTION

The present subject matter relates to techniques for optimizing logistics management of the supply chain. Generally, products in a supply chain network are shipped through various facilities of the supply chain, where a facility may be a unit or a part of the supply chain network. Examples of the supply chain network include hospital management, Fast-moving Consumer Goods, retail and e-commerce services, and the like. Products across the supply chain network are generally transported as a shipment from a source location to a target destination. For example, raw materials for a product may be transported from a supplier to a manufacturing unit. The manufacturing unit may further ship the products to warehouses for storage and from warehouses, the products may be shipped to distributors, and then finally to an end consumer, where the suppliers, manufacturing units, warehouses, distributors, and the end consumer form the supply chain network.

Typically, these products are shipped in pallets. Multiple units of a product are packed into cartons or outers, followed by multiple outers being packed into cases, and finally, multiple cases being packed into the pallets. In one example, these pallets may be transported from one facility of the supply chain network to another facility of the supply chain network. For example, each pallet containing multiple products may be shipped, for example, from one warehouse unit to another warehouse unit of the supply chain.

Also, at each facility of the supply chain, the products are identified, and information associated with the product, such as a location of the product, a status update of the product, number of products, and the like is updated into the tracking system of the supply chain for real-time visibility. This information helps in tracking products throughout the supply chain.

In logistics management of the supply chain, routes for shipments are typically decided based on past knowledge and are generally planned manually, where there is a set schedule and a set route which is taken for a particular shipment. For example, if a group of products are scheduled to be transported to six different facilities, the traditional approach would be to ship these products according to a pre-determined route based on manual analysis of the order of shipments. This may also result in sending multiple shipments on a single route, which would drive up the operational costs incurred.

Traditional approaches rely on collecting data associated with planning of routes for shipments from different facilities and the collected data is manually processed to derive insights with respect to assigning a shipment schedule. Such insights generally include aspects, such as total inventory count at a particular facility, ageing inventory, demand forecast, and the like, which may be derived based on the collected data. This approach is not only time-consuming, but is also cumbersome and is prone to errors, resulting in inaccurate accounting of the products. Also, routes for shipments are highly dependent on manual intervention and are not dynamically determined based on factors such as a sudden change in demand of the product associated with a concerned facility, or an inventory that needs to be shipped out on priority as a result of an event that has occurred in a particular facility, and the like. Further, at any point of time, the data associated with the products may be outdated to make informed decisions such as selecting an optimal route for the products are to be transported.

According to examples of the present subject matter, techniques to optimize logistics management of the supply chain are discussed. Techniques of the present subject matter utilize data, such as hierarchical information of a product in a shipment mix, historical path information, status of a product, historical inventory data, and the like for optimizing logistics management of the supply chain network. Hierarchical information is indicative how a unit of the product is shipped. For example, hierarchical information of the product may include details regarding in which pallet, case, and outer, a unit of the product is packed into and the historical path information, amongst other information, may include details regarding a path traversed by a particular unit of product.

For example, if a product ‘Z’ is to be shipped from facility ‘A’ to facility ‘E’, the hierarchical information of the product ‘Z’ would indicate the outer, the case, and the pallet, into which units of product ‘Z’ are packed into. Similarly, the historical path information may include information associated with the path traversed by the shipment mix carrying product ‘Z’, for example, the historical path information may indicate that the shipment mix was shipped out of facility ‘A’ at 10:00 am and reached facility ‘B’ at 12:00 pm, where the shipment mix traveled via route ‘X’. Subsequently, the shipment mix was shipped from facility ‘B’ to facility ‘D’, and the like, until the shipment mix finally reaches its assigned destination.

Further, data corresponding to the status of the product may indicate if the product or shipment mix has encountered any unforeseen events in the facility, such as theft, damages, discrepancies in accounting, and the like. For example, a few units of product ‘Z’ which were to be shipped to facility ‘E’ were left behind in facility ‘B’, and the like.

Additionally, for each product and a concerned facility may be obtained for demand-based route prediction, where routes may be optimized corresponding to a demand trend for a particular product of the facility. For example, historical inventory data pertaining to multiple products that are stored in the facility may be obtained and analyzed to predict the demand pattern for the particular product. For example, if a facility ‘X’ generally stores products ‘A’, ‘B’, and ‘C’, the historical inventory data for each of these products and historical inventory data associated with facility ‘X’ may be obtained. The historical inventory data obtained, along with the second data are analyzed to predict demand trends for various categories of demand, that would affect the movement or consumption of products. The various categories of demand could include seasonal variations demand, location-wise demand, age-wise demand, product-based demand, and the like. On predicting the demand for each of these products at various facilities of the supply chain, demand-based route optimization may be performed for a shipment mix to be transported.

In operation, a first data, which includes at least a first location and a second location associated with a shipment mix is obtained, where the shipment mix includes multiple products that are to be transported from the first location to the second location. In one example, the first location may be the source location of the shipment mix and the second location may be the assigned destination for the shipment mix, where the first location and the second location may be amongst the multiple facilities that form a part of the supply chain.

Along with the first data associated with the shipment mix; a second data associated with each product in the shipment mix is acquired. The second data, amongst other information, includes hierarchical information of the product, and a historical path information associated with the product. In one example, the hierarchical information may be indicative of a case in which a unit of the product is packed into, an outer into which the case is packed into, and a pallet into which the outer is packed into, and the like. Whereas the historical path information may be indicative of paths traversed by a similar shipment mix across various facilities of the supply chain historically. For example, the second data associated with the product may be an EPCIS data. It would be noted that the EPCIS data is GS1's data sharing standard for enabling visibility, within a facility as well as across the entire supply chain. The EPCIS data gathers data corresponding to transactions that happen on the product across different packing levels (pallet, case, outer, unit) and the EPCIS data is captured for a particular product without incurring additional infrastructure or workforce cost. For example, the EPCIS data for product ‘Z’ may provide information regarding the pallet, case, and outer in which product ‘Z’ is packed into. The path traveled by product ‘Z’ historically, and the like.

Based on the second data acquired, a derived inventory of the multiple products available within each facility is computed. The derived inventory of a facility may be generated based on the second data that is acquired for a product or the shipment mix. The derived inventory of each facility may then be compared to an actual inventory of the corresponding facility to generate a reconciled output. In one example, the reconciled output may be indicative of a discrepancy in the inventory in the shipment mix, a path in which the discrepancy has occurred, a probable time-period when the discrepancy could have occurred, and the like. For example, the reconciled output may indicate unnecessary replication or scarcity of products, and the like. The reconciled output along with the second data acquired for the product may be analyzed to generate feasible path layouts. The feasible path layouts generated may indicate multiple possible routes that may be taken to transport the shipment mix. Based on the multiple feasible path layouts generated, a recommended path for the shipment mix may be selected.

Additionally, the recommended path may be selected based on a demand pattern of a facility for a product. For example, if it is observed that in summer, the demand for product ‘Z’ is higher at a warehouse ‘X’ and the lifespan of product ‘Z’ is relatively shorter, the recommended path selected from the feasible path layouts generated may include a path in which warehouse ‘X’ may be the first destination for the shipment mix to be transported to, which includes product ‘Z’, and the like. In one example, techniques of the present subject matter also provide for modifying a shipment mix based on the optimal route that may be selected for transporting a shipment.

Therefore, techniques of the present subject matter provide optimized routes for efficient logistics management in a supply chain network which are cost effective and avoid any delays, unnecessary replication, or scarcity of products.

The above and other features, aspects, and advantages of the subject matter will be explained with regard to the following description and accompanying figures. It should be noted that the description and figures merely illustrate the principles of the present subject matter along with examples described herein and should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

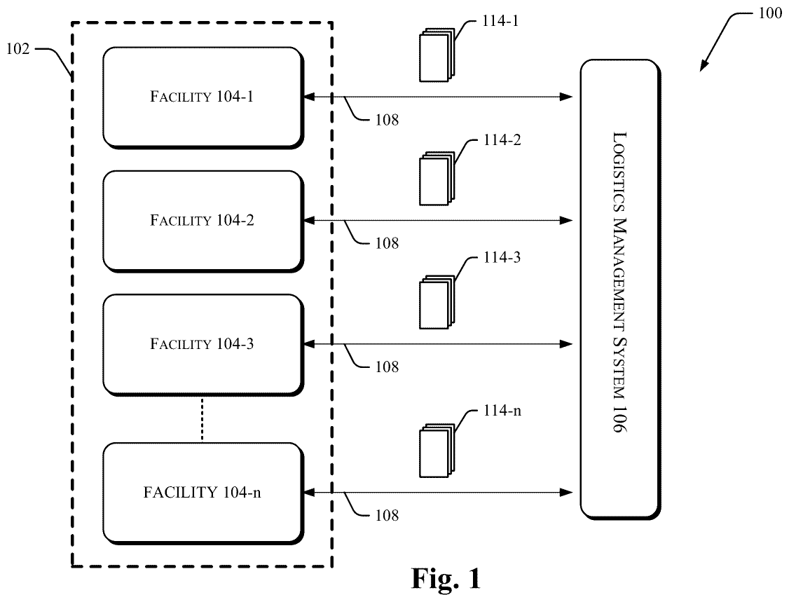

FIG. 1 illustrates a supply chain network environment 100, in accordance with an example implementation of the present subject matter. In one example, the supply chain network environment 100 may include a supply chain network 102 including multiple facilities, 104-1, 104-2, 104-3, . . . 104-n, collectively and alternatively referred to as multiple facilities 104 or facility 104. For example, but not limited to, the facility 104 may be a warehouse in a packaging industry, an assembling unit of an automobile manufacturing company, a consumer-goods manufacturing unit, an e-commerce storage unit, a cold storage of a food manufacturing company, a pharmaceutical manufacturing unit, a distributer of a logistics company, and the like. In one example, the multiple facilities 104 may be distributed across different locations in the supply chain network 102.

Each facility of the multiple facilities 104 may include a facility management system (not shown in the figure). In one example, the facility management system may be employed in each facility 104 for inventory management. In one example, the facility management system may be part of a source device (not shown in the figure), where the source device may be an Internet of things (IoT) device, a computing device, a personal computer, a laptop, a tablet, a mobile phone, and the like. In another example, the facility management system may be hosted on a server (not shown in the figure) that may communicate with the source device.

In one example, the facility management system of each of the multiple facilities 104 may be communicatively coupled to a logistics management system 106. The facility management systems and the logistics management system 106 may communicate over a network 108. The network 108 may be a wireless network or a combination of a wired and wireless network. The network 108 can also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN). Depending on the terminology, the communication network includes various network entities, such as gateways and routers; however, such details have been omitted to maintain the brevity of the description.

Further, the logistics management system 106 may be implemented in any computing system, such as a storage array, a server, a desktop or a laptop, a computing device, a distributed computing system, or the like. Although not depicted, the logistics management system 106 may include other components, such as interfaces to communicate over the network or with external storage or computing devices, display, input/output interfaces, operating systems, applications, data, and other software or hardware components (not depicted for the sake of brevity).

In one example, the logistics management system 106 may obtain data 114-1, 114-2, 114-3, . . . , 114-n, collectively referred to as data 114, from multiple facilities 104-1, 104-2, 104-3, . . . 104-n, respectively. In one example, the data 114 generated by the multiple facilities 104, amongst other information, may include information associated with products of the facility, such as hierarchical information of the product which includes pallet identifiers, case identifiers, outer identifiers, information associated with inventory of each product in the facility, historical path information, a target location to which the product needs to be transported, historical demand corresponding to the inventory of the facility, inventory stocking details, event identifiers, and the like. For example, in a facility, such as a warehouse, the data 114 could indicate different types of products available in the warehouse, existing inventory stocking details of the warehouse, a general demand forecast for the various products of the warehouse, details regarding packaging and tracking of the various products associated with the warehouse, such as the number of products that are in a pallet, hierarchical information and historical path information associated with each of the products in a shipment mix to be transported, details concerning the number of products that have been shipped to the warehouse recently, products that have be shipped out from the warehouse, and the like.

On obtaining the data 114 from each of the facilities 104 of the supply chain network 102, the logistics management system 106 may analyze the data 114. The logistics management system 106 may analyze the data 114 to generate feasible path layouts for transporting the shipment mix from one facility 104 of the supply chain network 102 to another facility 104 of the supply chain network 102, and the like. A recommended path from the feasible path layouts generated may be selected to optimize the logistics management of the supply chain network 102.

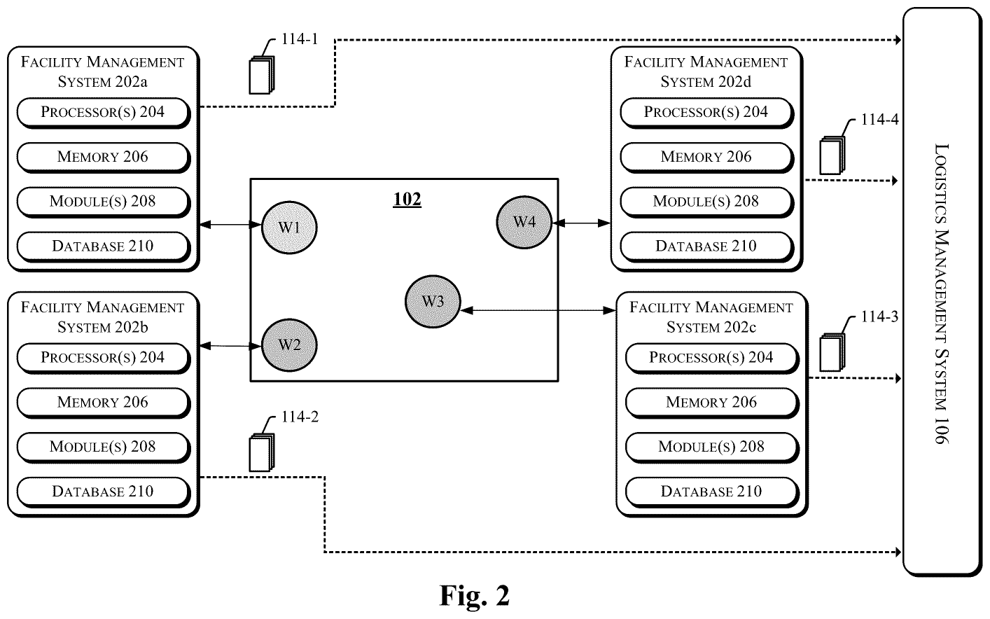

FIG. 2 illustrates an example supply chain network 102, in accordance with an example implementation of the present subject matter. In one example, the supply chain network 102 depicts multiple facilities 104. In this example, each facility 104-1, 104-2, 104-3, 104-4 of the supply chain network 102 may be a warehouse, located at different locations. For example, a first facility 104-1 of the multiple facilities 104 may be a warehouse ‘W1’ located in Texas, a second facility 104-2 of the multiple facilities 104 may be a warehouse ‘W2’ located in Denver, a third facility 104-3 of the multiple facilities 104 may be a warehouse ‘W3’ located in Toronto, and a fourth facility 104-4 of the multiple facilities 104 may be a warehouse ‘W4’ located in Illinois.

In one example, each warehouse of the supply chain network 102 may include a facility management system 202. The facility management system 202 may be employed to monitor inventory and logistics of the concerned warehouse. For example, each of the warehouses ‘W1’, ‘W2’, ‘W3’, and ‘W4’, may include a facility management system 202a, 202b, 202c, and 202d, respectively, where the facility management system 202a of warehouse ‘W1’, facility management system 202b of warehouse ‘W2’, facility management system 202c of warehouse ‘W3’, and the facility management system 202d of warehouse ‘W4’ may be communicatively coupled to the logistics management system 106.

For the sake of simplicity, the following description has been discussed with reference to the facility management system 202a of warehouse ‘W1’, of the supply chain network 102. However, it may be understood that similar principles may be applicable to all other facilities 104 of the supply chain network 102.

In one example, the facility management system 202a includes a processor 204 and a memory 206. The processor(s) 204 may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. The memory 206 may include any computer-readable medium including, for example, volatile memory (e.g., RAM), and/or non-volatile memory (e.g., EPROM, flash memory, etc.).

The facility management system 202a may further include modules 208, such as inventory management module (not shown). In one example, the inventory management module may be implemented as a combination of hardware and firmware. In examples described herein, such combinations of hardware and firmware may be implemented in several different ways. For example, the firmware for the module may be processor executable instructions stored on a non-transitory machine-readable storage medium and the hardware for the module may include a processing resource (for example, implemented as either a single processor or a combination of multiple processors), to execute such instructions.

In the present examples, the machine-readable storage medium may store instructions that, when executed by the processing resource, implement the functionalities of the modules 208. In such examples, the facility management system 202a may include the machine-readable storage medium storing the instructions and the processing resource to execute the instructions. In other examples of the present subject matter, the machine-readable storage medium may be located at a different location but accessible to the facility management system 202a and the processor(s) 204.

The facility management system 202a may further include a database 210, that serves, amongst other things, as a repository for storing data that may be fetched, processed, received, or generated by the modules. The data may include information associated with various products of the facility, such as inventory stocking data, historical path information associated with the products of the facility, hierarchical information corresponding to products of the facility, and the like.

In one example, the facility management systems 202a may obtain data associated with each product of the facility 104. In one example, the data may be stored in the database 210 of the facility management system 202a. For example, if warehouse ‘W1’ generally stores products ‘X’, ‘Y’, and ‘Z’, data corresponding to each of these products X’, ‘Y’, and ‘Z’ may be collected and stored in database 210 of the facility management system 202a.

Data associated with each product of the warehouse ‘W1’ may include hierarchical data associated with a product, historical path information of the product, events occurring in warehouse ‘W1’, inventory stocking details of the warehouse ‘W1’, historical inventory data for corresponding to the products in warehouse ‘W1’, and the like.

In one example, hierarchical information of product ‘X’ would include information corresponding to pallet identifiers that store product ‘X’, number of units of product ‘X’ available in warehouse ‘W1’, and the like. Historical path information of product ‘X’ may include a path traversed by, for example, a particular unit of product ‘X’, or a shipment mix containing product ‘X’ and the like. Inventory stocking details of warehouse ‘W1’ could include existing inventory details of the product ‘X’, details regarding packaging and tracking of each unit of product ‘X’, details concerning a number of units of product ‘X’ that have been shipped into the warehouse ‘W1’ recently, a number of units of product ‘X’ that have be shipped out from the warehouse ‘W1’, and the like. Further, data associated with an event that could occur in warehouse ‘W1’ may include, for example, details associated with the damage caused to a particular shipment that was received in the warehouse ‘W1’ due to an unforeseen accident, or discrepancy in the number of products received at the warehouse ‘W1’, and the like. Each event would be assigned an event identifier, such as an event ID. In one example, the event ID may be stored in the database 210 of the facility management system 202a. Further, data associated with historical inventory for products in warehouse ‘W1’ could include a general demand for product ‘X’ in warehouse ‘W1’ based on factors that assist in demand forecasting, such as seasonal variations demand, an age of the product ‘X’, a time period for which product ‘X’ has been stored in warehouse ‘W1’, and the like. Similar data for the other products of warehouse ‘W1’, and products of the other warehouses of the supply chain network may be collected.

In one example, data 114-1 from the first warehouse ‘W1’, data 114-2 from the second warehouse ‘W2’, data 114-3 form the third warehouse ‘W3’, and data 114-4 from the fourth warehouse ‘W4’, collectively referred to as data 114 of the supply chain network 102 may be communicated to the logistics management system 106. Based on such data 114 obtained from the facility management system 202 of various warehouses, the logistics management system 106 may analyze the data 114 to generate recommendations for logistics management in the supply chain network 102 by generating a demand forecast for products, feasible path layouts for transporting a shipment mix, recommending an appropriate shipment mix to be transported in an optimized manner amongst the various facilities 104 of the supply chain network 102, and the like.

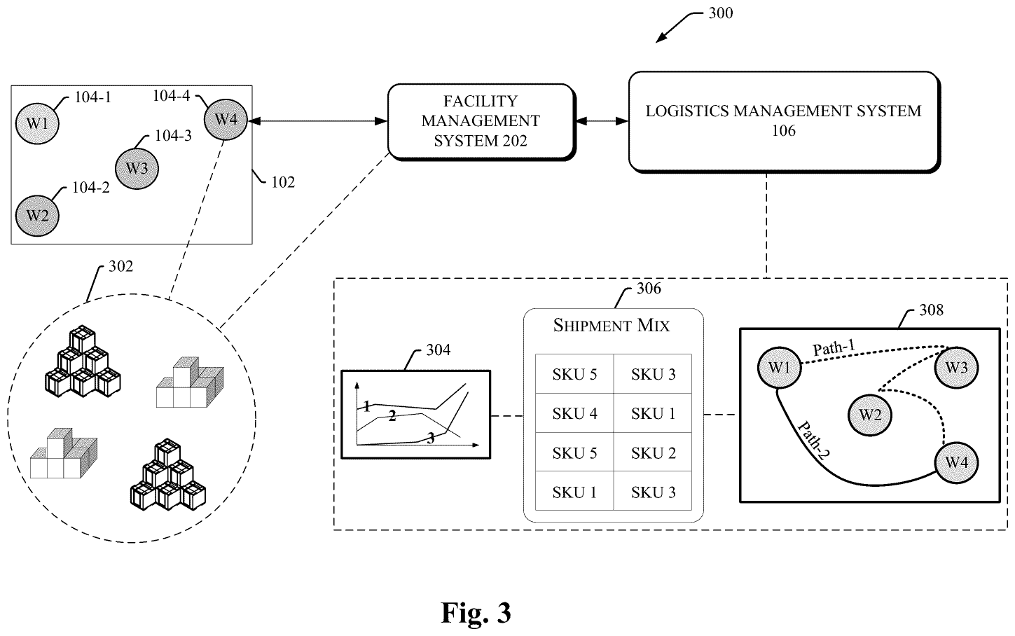

FIG. 3 illustrates another example of a supply chain network 300, in accordance with an example implementation of the present subject matter. In one example, historical inventory data 302 associated with each facility 104 may be obtained by the facility management system 202 of the corresponding facility 104 for inventory management and demand forecasting of the concerned facility 104. Similar to the example discussed above, each facility 104-1, 104-2, 104-3, 104-4, alternatively and collectively referred to as facility 104, may be a warehouse ‘W1’, ‘W2’, ‘W3’, and ‘W4’, respectively, and may be located at different geographical locations forming a part of the supply chain network 102.

In one example, the historical inventory data 302 may be indicative of a demand corresponding to each product of a concerned facility 104. A demand for a product of the facility 104 may be categorized into, for example, but not limited to, a seasonal variation-based demand, aging inventory-based demand, product-based demand, facility-based demand, location-based demand, and the like. Such historical inventory data 302, in addition to the hierarchical information of the product, and the historical path information of the product, may be analyzed to predict a demand for the various products in future. In one example, demand forecasting may be performed based on data obtained for a pre-determined time period, such as a duration of 1 year, 3 years, 2 months, and the like.

In one example, the historical inventory data 302 collected may be obtained by the facility management system 202 associated with each facility 104 of the supply chain network 102 and may be communicated to the logistics management system 106. The historical inventory data 302, the hierarchical information of the product, and the historical path information of the product are utilized for demand forecasting to generate a demand pattern 304. In another example, the facility management system 202 associated with each facility 104 of the supply chain network 102 may perform demand forecasting to generate the demand pattern 304. The demand pattern 304 generated may then be accessed by the logistics management system 106. In one example, techniques of machine learning may be utilized to generate multiple demand patterns 304, for example, indicated by trend lines 1, 2, and 3, associated with the various categories of demand. For example, demand patterns associated with various categories of demand include seasonal variations-based demand pattern 304, facility-based demand pattern 304, product-based demand pattern 304, ageing inventory-based demand pattern 304, and the like.

Based on the demand patterns 304 generated for each category of demand, a recommendation in correspondence to the demand pattern 304 may be generated. In one example, the recommendation may be generated by the logistics management system 106. For example, based on the demand patterns 304 generated, and the current inventory of the concerned facilities, a recommendation to re-shuffle the inventory between the various facilities of the supply chain network may be generated, or recommendation for replenishment of inventory to meet a predicted demand may be generated, a recommended route for transporting shipments based on the demand, and the like.

In one example, EPCIS data associated with a product of the shipment mix may be extracted and the demand pattern 304 may be generated based on the EPCIS data and historical inventory data. For example, in one scenario, the demand pattern 304 may be generated in correspondence to hierarchical information of the product, historical path information of the product and seasonal variations in warehouses ‘W1’, ‘W2’, ‘W3’, and ‘W4’, where the demand pattern 304 generated may indicate that warehouse ‘W3’ does not have sufficient inventory to meet the demand predicted in season ‘X’. However, warehouse ‘W2‘ and warehouse’W4’ have excess inventory for the same season. Based on this demand pattern 304, a recommendation to reshuffle inventory from warehouse ‘W2‘ and warehouse’W4’ may be initiated in order to equip warehouse ‘W3’ with sufficient inventory for the demand predicted. In one example, a user may initiate the replenishment of the inventory. For example, a manager of the warehouse ‘W1’ may initiate replenishment of the inventory.

In another example, the demand pattern 304 may be generated in correspondence to aging inventory. Recommendations for aging inventory-based demand may be generated in correspondence to an age of the product, where aging inventory of the warehouse may be identified based on an expiration date of the product. Aging inventory across each warehouse of the supply chain network 102 may be assessed and dispatching of products from the warehouse may be performed based on their expiration dates. In one example, a priority may be assigned to each product of the warehouse based on the expiration of the product. While modifying the shipment mix and analyzing data to generate feasible path layouts for shipment of products, the priority assigned to the product may be considered. For example, products assigned with higher priority, i.e., products with a closer expiration date may be shipped out from the warehouse earlier than the products assigned with a lower priority, i.e., with a later expiration date, and the like.

Further, demand patterns 304 may also be utilized for recommending a shipment mix 306, where the shipment mix 306 may be populated with multiple products or Stock Keeping Units (SKUs). In one example, the shipment mix 306 may be populated based on the demand patterns 304 that is generated for various categories of demand for optimal management of inventory in the facility of the supply chain.

Further, feasible path layouts (not depicted in the figure) for transporting the shipment mix 306 from one facility to another facility amongst the multiple facilities of the supply chain network 102 may be generated. In one example, the logistics management system 106 may select a recommended path 308 from the feasible path layouts generated based on the demand pattern 304 and details associated with the shipment mix 306. Accordingly, techniques of the present subject matter facilitate in timely and efficient management of inventory and route optimization based on demand patterns which further enhances logistics management.

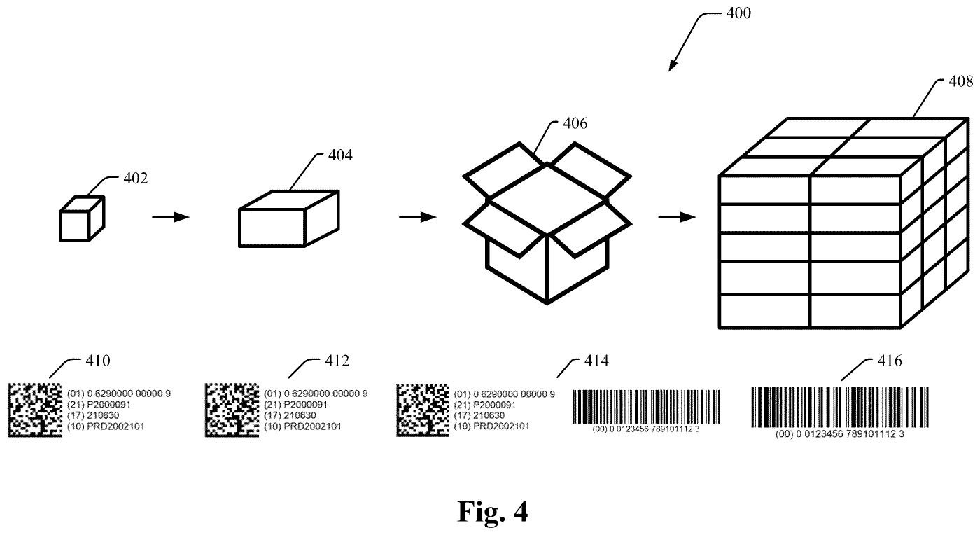

FIG. 4 illustrates hierarchical information 400 associated with a product, in accordance with an example implementation of the present subject matter. In one example, hierarchical information 400 associated with a single unit of a product 402 may indicate how the product 402 is packed. For example, multiple units of the product 402 may be packed into an outer 404. Multiple outers 404 may be packed into a case 406 and finally, multiple cases 406 may be packed into a pallet 408. In one example, the shipment mix (not depicted in the figure) to be transported amongst multiple facilities of the supply chain network may contain, for example, a mix of such pallets 408. In one example, hierarchical information 400 of the product 402 may be based on Electronic Product Code Information Services (EPCIS), a global system of standards (GS1) standard.

In one example, a product unique identifier 410, alternatively referred to as product unique ID, may be generated for each unit of the product 402. In one example, a unit of the product 402 may be a saleable unit. Further, the product unique ID 410 may be generated for each unit of the product 402 based on the GS1 standard. Similarly, an outer unique ID 412 may be generated for each outer 404 which would indicate a parent-child relationship of the multiple units of the product 402 stored in the corresponding outer 404, a case unique ID 414 may be generated for each case 406 which would indicate a parent-child relationship of the multiple units of outers 404 stored in the corresponding case 406, and a pallet unique ID 416 may be generated for each pallet 408 which would indicate a parent-child relationship of the multiple units of cases 406 stored in the corresponding pallet 408. In one example, the case unique ID 414 generated for cases 406 and the pallet unique ID 416 generated for the pallets may be a GS1-128 barcode, or a Serial Shipping Container Code (SSCC).

Further, the pallet unique ID 416 would be indicative of the multiple cases 406 packed into the pallet 408, the case unique ID 414 would be indicative of the multiple outers 404 packed into the case 406, the outer unique ID 412 would be indicative of the multiple products 402 packed into the outer 404, and the like. Each of the product unique ID 410, the outer unique ID 412, the case unique ID 414, and the pallet unique ID 416, amongst other information, may be indicative of a serialized Global Trade Item Number (GTIN), a serial number, an expiry date, and a batch number.

In one example, on scanning the pallet unique ID 416, the case unique ID 414, or the outer unique ID 412, information corresponding to the cases, outers, and products associated with each of the unique ID may be obtained. For example, if a pallet unique ID 416 is scanned, all the cases, outers, and products, along with their respective unique IDs stored in that specific pallet may be obtained. Although hierarchical information 400 has been discussed with respect to a unit of the product, outers, cases, and pallets, principles of the present subject matter would be applicable to other techniques for packaging and tracking of products and should not be construed as a limitation.

For example, on considering a warehouse that includes products ‘X’, ‘Y’, and ‘Z’. The warehouse may contain 1000 units of product ‘X’, 500 units of product ‘Y’, and 1000 units of product ‘Z’. Each unit of product ‘X’ would be assigned with the first code that is indicative of the serial GTIN, serial number, expiry date, and batch number. Further, 1000 units of product ‘X’ may be packed into 10 cases, each case having 100 products. The code assigned to each case would indicate the units of product ‘X’ they contain. Similarly, 2 cases may be packed into one outer, where each outer would indicate the cases, the outer contains and the units of product ‘X’ the outer contains, and the like. Such hierarchical information 400 associated with each product 402 along with historical path information, event data, and historical inventory data may be utilized to optimize the logistics of the supply chain network 102.

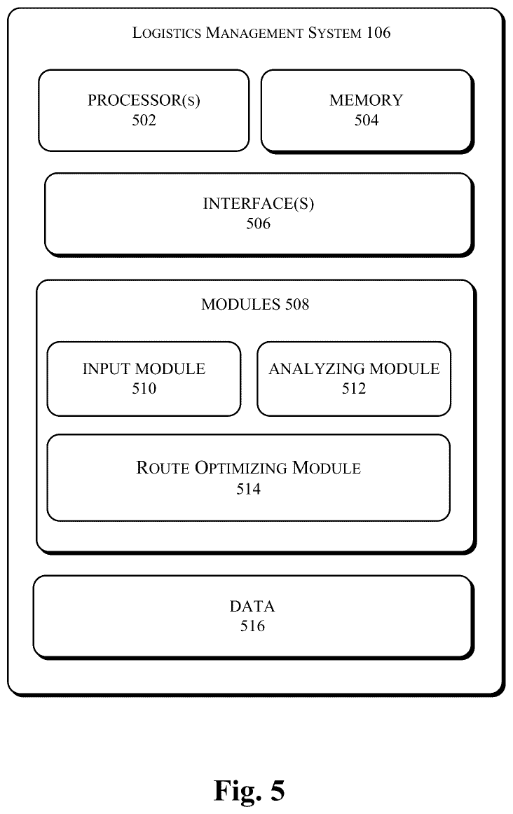

FIG. 5 illustrates a logistics management system 106, in accordance with an example implementation of the present subject matter. In one example, the logistics management system 106, alternatively referred to as system 106, may optimize logistics for a supply chain network 102.

In one example, the logistics management system 106 may include a processor 502 and a memory 504 coupled to the processor 502. The functions of functional block labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. Further, an interface(s) 506 may allow the connection or coupling of the system 106 with one or more other devices (say devices or systems within the supply chain network), through a wired (e.g., Local Area Network, i.e., LAN) connection or through a wireless connection (e.g., Bluetooth®, Wi-Fi). The interface(s) 506 may also enable intercommunication between different logical as well as hardware components of the system 106.

The memory 504 may include any computer-readable medium including, for example, volatile memory (e.g., RAM), and/or non-volatile memory (e.g., EPROM, flash memory, etc.).

The logistics management system 106 may further include modules 508, such as an input module 510, an analyzing module 512, and a route optimizing module 514. In one example, module(s) 508 may be implemented as a combination of hardware and firmware. In examples described herein, such combinations of hardware and firmware may be implemented in several different ways. For example, the firmware for the module may be processor executable instructions stored on a non-transitory machine-readable storage medium and the hardware for the module may include a processing resource (for example, implemented as either a single processor or a combination of multiple processors), to execute such instructions.

In the present examples, the machine-readable storage medium may store instructions that, when executed by the processing resource, implement the functionalities of the module(s) 508. In such examples, the logistics management system 106 may include the machine-readable storage medium storing the instructions and the processing resource to execute the instructions. In other examples of the present subject matter, the machine-readable storage medium may be located at a different location but accessible to the logistics management system 106 and the processor 502.

The logistics management system 106 may further include data 516, that serves, amongst other things, as a repository for storing data that may be fetched, processed, received, or generated by the modules 508. The data 516 may include communication data, location data, hierarchical information associated with each product, historical path information, event data, historical inventory data, feasible path layouts, demand patterns, and the like. In an example, the data 516 may be stored in the memory 504.

The input module 510 of the logistics management system 106 may obtain a first data including at least a first location and a second location associated with a shipment mix to be transported amongst multiple facilities located at different locations that form a part of the supply chain. In one example, the first location may correspond to a source location from where the shipment mix may have to be shipped out and the second location may correspond to an assigned destination to which the shipment mix is to be shipped. In one example, the shipment mix may include multiple products.

In addition to the first data, the input module 510 is to acquire a second data associated with each product amongst multiple products of the shipment mix. In one example, the second data associated with the product amongst the plurality of products may be an Electronic Product Code Information Services (EPCIS) data belonging to the global GS1 standard. In another example, the second data associated with the product amongst the plurality of products may be similar to the EPCIS data belonging to the global GS1 standard. Although techniques of the present subject matter are discussed based on EPCIS data belonging to GS1 standard, it may be understood that principles of the present subject matter may be applicable to similar data coding and tracking standards.

In one example, the second data may include, amongst other information, a hierarchical information of the product and a historical path information of the product. In one example, hierarchical information of the product may include data as described with reference to FIG. 4, which would include details regarding a pallet, a case, an outer, and the like, into which a particular unit of the product is packed into. The historical path information may include details regarding a path traversed by a particular unit of the product, or the shipment mix. In one example, if the shipment mix includes products ‘U’, ‘V’, and ‘W’, and if the shipment mix has travelled from a first location, such as a first warehouse of the supply chain and has travelled across a second warehouse, a third warehouse, and a fourth warehouse to finally reach the second location, such as a fifth warehouse, of the supply chain network, the historical path information associated with products ‘U’, ‘V’, and ‘W’ would be indicative of the path traversed between these warehouses from the first location to the second location of the supply chain. In another example, historical path information of the product would include paths traversed by a similar shipment mix including the same or similar products across various facilities of the supply chain historically.

Additionally, second data may include an event data, where the event data is generated corresponding to an event. In one example, the event may be associated with each facility. In another example, the event may be associated with the product of the shipment mix. In yet another example, the event may be associated with each facility as well as the product of the shipment mix. In one example, the event may affect an initial status of the product in the shipment mix. In one example, the event may alter an initial status of the product. For example, an event may relate to a pilferage that may occur while the shipment is being transported across various facilities, or a temperature of the shipment mix increases beyond the set threshold, or one of the products may be damaged due to the mode of transport, or if a shelf in a warehouse containing a specific product gets damaged, or the like.

In one example, each event that may occur at the concerned facility or is associated with the product may be assigned with an event identifier. In one example, the input module 510 may obtain the event identifier from the facility management system 202 employed in the concerned facility, as discussed earlier. The event identifier may assist in extracting information associated with the event. For example, but not limited to, the information associated with the event may indicate a time of occurrence of the event, a frequency of occurrence of the event, number of products transported out of one facility and the number of products received at another facility, a condition of the products received at the facility, a number of products missing from a shipment mix, repetition of accounting in products, and the like.

In one example, the event identifier may be stored in the data 516 of the logistics management system 106. For example, a shelf in warehouse storing pallets to be transported from the said warehouse to another warehouse of the supply chain may be subjected to an unforeseen accident, and four pallets out of the 10 pallets that were to be shipped may be associated with some damage. Such an accident may be identified as an event and may be assigned with an event identifier.

Additionally, the second data may also include historical inventory data. In one example, the historical inventory data may be associated with the product. In another example, the historical inventory data may be associated with a concerned facility of the supply chain network 102. In one example, in addition to the hierarchical information of the product, historical path information associated with the product, and event data, historical inventory data may be utilized for demand forecasting. In one example, demand trends for various categories of demand, for example, but not limited to, a seasonal-based demand, aging inventory-based demand, product-based demand, facility-based demand, location-based demand, and the like may be generated. In one example, the data 516 may store the various demand patterns for further analysis.

In one example, on obtaining the first data and the second data associated with the shipment mix, the analyzing module 512 of the logistics management system 106 may compute a derived inventory of the multiple products available within each facility 104 amongst the multiple facilities 104 of the supply chain 102. Further, the derived inventory may be compared with an actual inventory of each facility to generate a reconciled output. In one example, the actual inventory of each facility may be obtained from an inventory database corresponding to each facility. In one example, the actual inventory of a concerned facility may be obtained from the facility management system 202.

On computing the derived inventory, the derived inventory for a facility 104 is compared with the actual inventory of the concerned facility to generate the reconciled output. In one example, the reconciled output may be indicative of a current status of the product. For example, the reconciled output may be indicative of a discrepancy in the inventory. In another example, the reconciled output may be indicative of a path of the shipment mix in which the discrepancy has occurred. The reconciled output may also indicate a time at which the discrepancy has occurred.

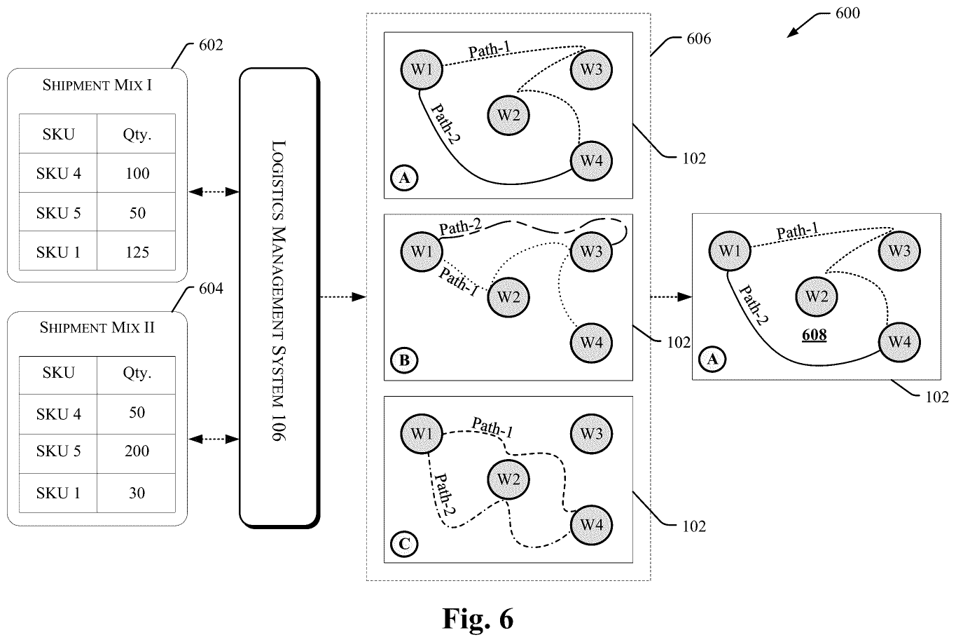

In addition to generating the reconciled output, the analyzing module 512 is to analyse the reconciled output generated along with the second data acquired associated with the product to generate feasible path layouts to transport a particular shipment mix from the first location to the second location. The one or more feasible path layouts generated may represent optimal routes in which the shipment mix can be transported. Generation of the one or more feasible path layouts is discussed in detail with reference to FIG. 6.

In one example, the route optimizing module 514 of the logistics management system 106 may generate a recommendation to select a recommended path from the feasible path layouts generated. The recommendations may be based on a demand-based route prediction, an economical path to transport the shipment mix, a current status of the product, and the like. Accordingly, a recommended path may be selected from the recommendations generated. In one example, based on the recommended path that is selected, the second location, i.e., the location to which the shipment mix is to be transported to may be modified to a third location. For example, in one scenario, the shipment mix may be scheduled to be transported from warehouse ‘A’ to warehouse ‘B’, where warehouse ‘A’ would be the first location and warehouse ‘B’ would be the second location of the supply chain network. However, based on, for example, but not limited to, a demand pattern updated dynamically, the logistics management system 106 may generate a few feasible path layouts and accordingly, select a recommended path to transport the shipment mix to warehouse ‘C’ instead of warehouse ‘B’ to meet the change in demand, and thus efficiently optimizing the logistics of the supply chain network 102.

Additionally, the logistics management system 106 may also generate a recommendation to modify the shipment mix based on the recommend route selected for transporting the shipment mix. In one example, optimization for the shipment mix, or optimization of the route for transporting the shipment mix, or a combination of both may be provided by a user. Based on the input provided by the user, appropriate recommendations for shipment mix modification, or route optimization, or both, may be generated.

Therefore, techniques of the present subject matter account for any discrepancy, such as theft, damages, and the like, that could occur to a product of the shipment mix, and dynamically update the second data and the reconciled output to analyze the feasible path layouts to be generated, and subsequently recommend an action of either optimizing the shipment mix, or routes to transport the shipment mix. Accordingly, techniques of the present subject matter facilitate in dynamic and real time optimization of routes and shipment mixes in correspondence to the current status of the product, thereby enhancing logistics management of the supply chain network.

FIG. 6 illustrates an example of route optimization 600, in accordance with an example implementation of the present subject matter. In one example, on considering two shipment mixes, shipment mix I 602 and shipment mix II 604, to be transported amongst multiple warehouses ‘W1’, ‘W2’, ‘W3’, and ‘W4’ across the supply chain network 102, one or more feasible path layouts 606 may be generated, for each of the shipment mix I 602 and shipment mix II 604. For example, the supply chain network 102 may include a first warehouse ‘W1’ located in Texas, a second warehouse ‘W2’ located in Georgia, a third warehouse ‘W3’ located in Chicago, and a fourth warehouse ‘W4’ located in France. Based on the first data and the second data obtained from each of these warehouses, the feasible path layouts 606 may be generated. In one example, in addition to the second data, the logistics management system 106 may obtain sensor data (not shown in the figure). The sensor data may be obtained from one or more sensors associated with the products of the shipment mix I 602 and shipment mix II 604, the first warehouse ‘W1’, the second warehouse ‘W2’, the third warehouse ‘W3’, and the fourth warehouse ‘W4’, a mode of transport carrying the shipment mixes, and the like.

In one example, the one or more sensors may be Internet of Things (IoT) sensors, such as motion sensors, temperature sensors, pressure sensors, level sensors, proximity sensors, and the like. For example, GPS sensors may be located on the mode of transport carrying the shipment mix I 602 and shipment mix II 604. Sensor data from these GPS sensors, in addition to the first data, the second data, and the reconciled output generated, may be monitored and analyzed to generate the feasible path layouts 606. In another example, temperature sensors may be associated with the products packed into shipment mix I 602 and shipment mix II 604, where for example, the temperature sensors may indicate a rise in temperature of the products beyond a preset threshold. Data from these temperature sensors may be obtained by the logistics management system 106 for generating the feasible path layouts 606.

In another example, the feasible path layouts 606 may be generated based on a demand pattern, where each path layout may be generated in correspondence to a particular category of demand, as discussed with reference to FIG. 3. For example, the feasible path layout may be generated based on a seasonal demand pattern, SKU-wise demand pattern, aging inventory-based demand pattern, location-wise demand pattern, and the like. In yet another example, the feasible path layouts 606 may also be generated based on a best mode of transport that may be suitable for the shipment mixes, or routes that would be most economical for the shipment mixes to be transported, or paths suitable for a particular mode of transport that is chosen, and the like.

The following example is only to illustrate principles of the present subject matter and is not to be construed as a limitation. In one example, the logistics management system 106 may generate three feasible path layouts ‘A’, ‘B’, and ‘C’ in correspondence to the first data, the second data, and the sensor data. For example, shipment mix I 602 and shipment mix II 604 may include a variety of Stock Keeping Units SKU 4, SKU5, and SKU 1, of varying quantities, which are to be transported from the first warehouse ‘W1’ to the fourth warehouse ‘W4’. Based on the first data, second data, reconciled output, and the sensor data associated with shipment mix I 602 and shipment mix II 604, feasible path layouts ‘A’, ‘B’, and ‘C’ may be generated.

In one example, from the feasible path layouts ‘A’, ‘B’, and ‘C’ generated for transporting the shipment mix I 602 and the shipment mix II 604. Feasible path layout ‘A’ may depict two paths, path-1 and path-2, where path-1 is for transporting the shipment mix I 602 and path-2 is for transporting the shipment mix II 604. Path-1 indicates the shipment mix I 602 could start from the first warehouse ‘W1’, travel to the third warehouse ‘W3’ from the first warehouse ‘W1’, subsequently travel to the second warehouse ‘W2’ from the third warehouse ‘W3’, and the finally to the fourth warehouse ‘W4’ from the second warehouse ‘W2’. Similarly, path-2 indicates the shipment mix II 604 could be shipped to the fourth warehouse ‘W4’ directly from the first warehouse ‘W1’.

In one example, path-1 and path-2 of the feasible path layout ‘A’ may be generated based on the most suitable route that could be taken for a particular mode of transport chosen for each of the shipment mixes. In one example, shipment mix I 602 and shipment mix II 604 may be transported through a similar mode of transport. In another example, shipment mix I 602 may be transported through a first mode of transport and shipment mix II 604 may be transported through a second mode of transport. For example, shipment mix I 602 may be transported by road, and shipment mix II 604 may be transported by air.

In another example, similar to the feasible path layout ‘A’, feasible path layout ‘B’ may be generated for transporting the shipment mixes 602, 604, which is indicative of two paths, path-1 and path-2. Path-1 may be considered for transporting shipment mix I 602 and path-2 may be considered for transporting shipment mix II 604. In one example, the feasible path layout ‘B’ may be generated based on a seasonal based demand pattern for the first warehouse ‘W1’, the second warehouse ‘W2’, the third warehouse ‘W3’, and the fourth warehouse ‘W4’ of the supply chain 102.

In one example, a recommended path 608 may be selected from the feasible path layouts ‘A’, ‘B’, and ‘C’ generated. In one example, the feasible path layouts generation and selection of the recommended path from the generated feasible path layouts may be based on techniques involving machine learning and the like, where the most optimal path layout may be recommended. In another example, the recommended path 608 may be selected based on a user input. In one example, the recommended path 608 may be selected based on a user input, where the user would like to optimize routes based on various factors, such as demand patterns, products of the shipment mix, economical routes for transporting the shipment mix, and the like. For example, if the user wishes to optimize routes based on the optimizing the route based on a mode of transport, the feasible path layout ‘A’ generated for optimal routes in correspondence to the mode of transport may be selected as the recommended path 608.

In another example, in a scenario where, a logistics manager of the supply chain 102 observes that as per the demand patterns generated for ageing inventory, products in shipment mix II 604 are closer to their expiry date when compared to the products in shipment mix I 602, the user may wish to optimize routes for transporting the shipment mixes based on the age-wise inventory-based demand pattern. Accordingly, a path best suited to transport the shipment mix II 604 may be selected by the logistics manager, from the feasible path layouts generated, while accommodating the demand for the products in the said shipment in the other warehouses of the supply chain 102, and the like.

Also, in one example, based on the recommended path 608 selected, the mode of transport most suitable for the shipment mix may be selected. For example, the logistics management system 106 may suggest an optimum mode of transport for transporting the shipment mix, thereby increasing the efficiency in logistics management. For example, considering the first example discussed with reference to the feasible path layout ‘A’, it may be efficient to transport shipment mix I 602 from the first warehouse ‘W1’ to the fourth warehouse ‘W4’ by road, and to transport shipment mix II 604 from the first warehouse ‘W1’ to the fourth warehouse ‘W4’ through airways or waterways, and the like.

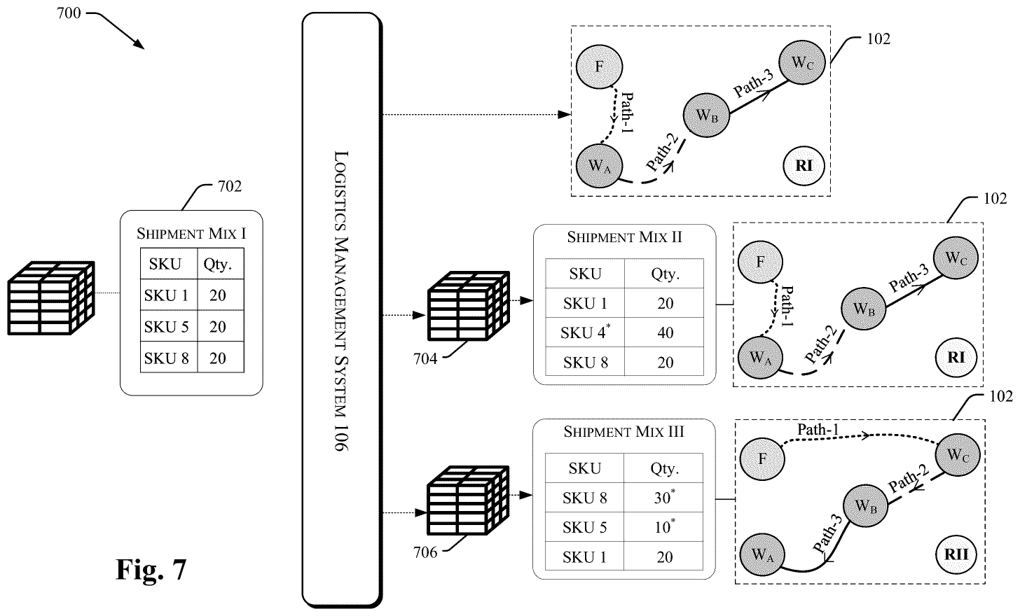

FIG. 7 illustrates another example of route optimization 700, in accordance with an example implementation of the present subject matter. In one example, the logistics management system 106, in addition to route optimization, may also modify the shipment mix to be transported. In one example, based on the feasible path layouts generated, and the recommended path selected, there may be a scenario in which modification of the shipment mix to be transported on the recommended path would further enhance the logistics management of the supply chain 102. In such a scenario, the shipment mix with a first set of products, or a first quantity of the first set of products may be modified to a new shipment mix containing a second set of products or a second quantity of the first set of products that would be best suited for recommended path that is selected. In another example, the shipment mix may be modified based on the demand pattern generated for various categories of demand, in addition to the recommended path that is selected. In yet another example, a user may provide an input to the logistics management system 106 for modifying the shipment mix.

The following example illustrates two different scenarios for modifying the shipment mix I 702 and is not to be construed as a limitation. A first scenario is described where for a recommended path I ‘RI’ selected for the shipment mix I 702, the shipment mix I 702 is modified to shipment mix II 704.

For example, the initial SKU quantities of the shipment mix I 702 may be about 20 units for each SKU, where the products of each SKU are the same, such as product ‘X’. The shipment schedule for shipment mix I 702 containing SKU 1, SKU 5, and SKU 8 may require SKU 1 to be shipped from a manufacturing facility F to warehouse ‘W_{A}’ through path-1, SKU 5 to warehouse ‘W_{B}’ through path-2, and SKU 8 to warehouse ‘W_{C}’ through path-3 based on the selected recommended path I ‘RI’. However, based on the demand pattern that may be generated or accessed by the logistics management system 106, it may be observed that due to a discrepancy in warehouse ‘W_{B}’, warehouse ‘W_{B}’ would require an SKU of another product, product ‘Y’ instead of product ‘X’. Based on this analysis, techniques of the present subject matter provide for modifying the shipment mixI 702 to shipment mix II 704, where the shipment mix II 704 would include 20 units of product ‘X’ for SKU 1, 40 units of product ‘Y’ for the new SKU 4*, and 20 units of products ‘X’ for SKU 8. The shipment mix II 704 would utilize the recommended path ‘RI’ to complete the shipment.

In a second scenario, for a recommended path I ‘RI’ selected for the shipment mix I 702, the shipment mix I 702 may be modified to shipment mix III 706, and subsequently for the modified shipment mix III 706, the recommended path I ‘RI’ may be modified to recommended path II ‘RII’.

For example, the initial SKU quantities in shipment mix I 702 may be about 20 units for each SKU, where the products of each SKU are the same, containing product ‘X’. The shipment schedule for shipment mix I containing SKU 1, SKU 5, and SKU 8 may require SKU 1 to be shipped from a manufacturing facility ‘F’ to warehouse ‘W_{A}’ through path-1, SKU 5 to warehouse ‘W_{B}’ through path-2, and SKU 8 to warehouse ‘W_{C}’ through path-3 based on the selected recommended path I ‘RI’. However, based on the demand pattern that may be generated or accessed by the logistics management system 106, it may be observed that historically, warehouse ‘W_{C}’ utilizes 30 units of product ‘X’ and warehouse ‘W_{B}’ utilizes only 10 units of product ‘X’, and that warehouse ‘W_{C}’ has a more urgent requirement of the shipment. Based on this analysis, techniques of the present subject matter provide for modifying the shipment mix I 702 to the shipment mix III 706, where the shipment mix III 706 would include 30 units of product ‘X’ for new SKU 8*, 10 units of product ‘X’ for new SKU5*, and 20 units of product ‘X’ for SKU 1. Additionally, the logistics management system 106 may also determine recommended path II ‘RII’ based on the corresponding demand pattern utilized for modifying the shipment mix I 702 to shipment mix III 706, where the recommended path II ‘RII’ would suggest that the vehicle carrying the shipment mix III 706 with SKU 1, new SKU 5*, and new SKU 8* could travel from the manufacturing facility ‘F’ through path-1 first to warehouse ‘W_{C}’ to deliver new SKU-8*, from warehouse ‘W_{C}’ to warehouse ‘W_{B}’ through path-2 to deliver new SKU 5*, and then to warehouse ‘W_{A}’ through path-3 to deliver SKU 1.

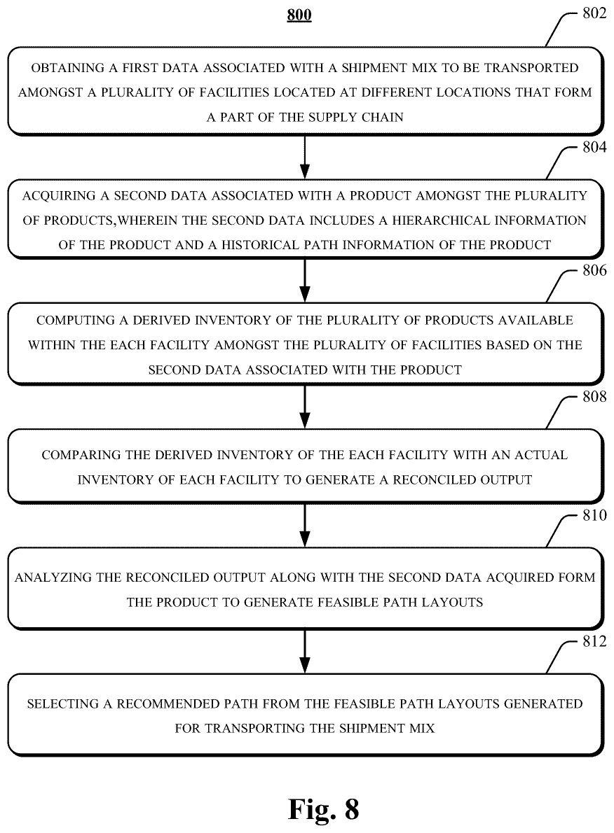

FIG. 8 illustrates a method 800 for logistics management, in accordance with an example implementation of the present subject matter. The order in which the method 800 is described is not intended to be construed as a limitation, and any number of the described method blocks can be combined in any order to implement method 800 or an alternative method. Additionally, individual blocks may be deleted from the method 800 without departing from the spirit and scope of the subject matter described herein. Furthermore, the method 800 may be implemented in any suitable hardware, computer readable instructions, firmware, or combination thereof. For discussion, the method 800 is described with reference to the implementations illustrated in FIG.(s). 1-6.

At block 802, the method 800 includes obtaining a first data including a first location and a second location associated with a shipment mix to be transported amongst a plurality of facilities. In one example, the plurality of facilities may be located at different locations that form a part of the supply chain. Further, the shipment mix to be transported from the first location to the second location may include multiple products.

At block 804, the method 800 includes acquiring a second data associated with a product amongst the plurality of products, where the second data includes a hierarchical information of the product and a historical path information of the product. In one example, the second data associated with the product amongst the plurality of products is an Electronic Product Code Information Services (EPCIS) data belonging to the global GS1 standard. In one example, the hierarchical information of the product may be indicative of indicative of a case in which a unit of the product is packed into, an outer into which the case is packed into, and a pallet into which the outer is packed into. In one example, the historical path information associated with the product may be indicative of a path traveled by the product or the shipment mix. In another example, the historical path information is indicative of paths traveled by a similar shipment mix across various facilities of the supply chain historically.

In one example, in addition to the hierarchical information of the product and the historical path information of the product, the second data may include an event data. The event may be associated with the product, the shipment mix carrying the product, or a concerned facility, for example, a facility to which the product is being shipped to. In one example, the event may affect an initial status of the product in the shipment mix. For example, any unforeseen accident in the facility, theft, damage, discrepancies in accounting, change in status of the product due to damage, and the like, may be considered to be an event that is either associated with the facility or the product.

At block 806, the method includes computing a derived inventory of the plurality of products available within each facility amongst the plurality of facilities based on the second data associated with the product.

At block 808, the method 800 includes comparing the derived inventory of each facility with an actual inventory of each facility to generate a reconciled output. In one example, the actual inventory of each facility may be obtained from an inventory database corresponding to each facility. Further, the reconciled output generated on comparing the derived inventory and the actual inventory of a concerned facility may be indicative of discrepancy in the inventory and a path in which the discrepancy has occurred of the shipment mix.

At block 810, the method 800 includes analyzing the reconciled output along with the second data acquired form the product to generate feasible path layouts. In one example the feasible path layouts may be indicative of the routes that may be taken to transport the shipment mix from the first location to the second location. In one example, in addition to analyzing the reconciled output along with the second data, sensor data from multiple sensors associated with at least one of the shipment mix and a mode of transport of the shipment mix may be obtained to generate the feasible path layouts.

At block 812, the method 800 includes selecting a recommended path from the feasible paths generated for transporting the shipment mix. In one example, the recommended path may be the most optimal path for transporting the shipment mix. In one example, based on the recommended path that is selected, a mode of transport to ship the shipment mix from the first location to the second location of the supply chain network may also be provided. In one example, based on the recommended path selected, the shipment mix may be modified to further enhance the logistics management of the supply chain network 102.

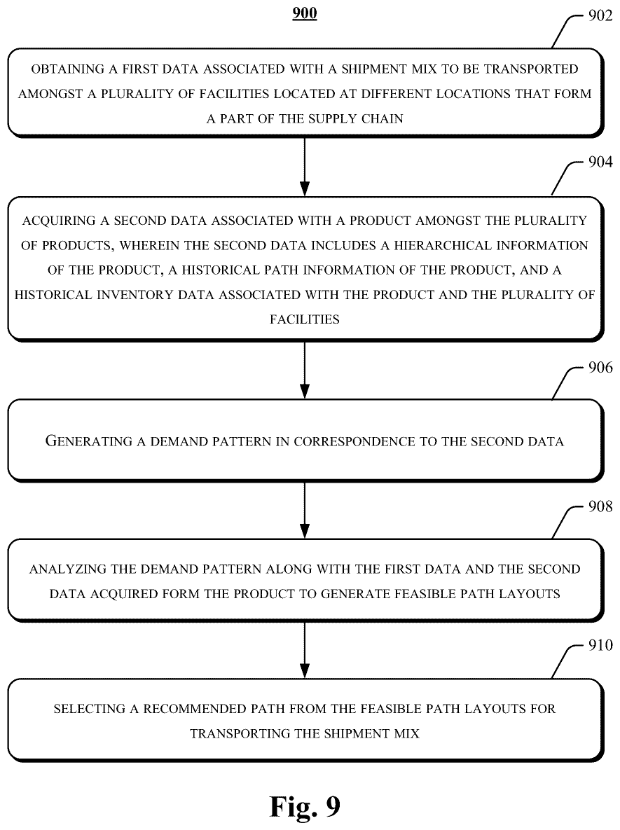

FIG. 9 illustrates another method 900 for logistics management, in accordance with an example implementation of the present subject matter. The order in which the method 900 is described is not intended to be construed as a limitation, and any number of the described method blocks can be combined in any order to implement method 900 or an alternative method. Additionally, individual blocks may be deleted from the method 900 without departing from the spirit and scope of the subject matter described herein. Furthermore, the method 900 may be implemented in any suitable hardware, computer readable instructions, firmware, or combination thereof. For discussion, the method 900 is described with reference to the implementations illustrated in FIG.(s). 1-6.

At block 902, the method 900 includes obtaining a first data that includes at least a first location and a second location associated with a shipment mix to be transported amongst a plurality of facilities located at different locations that form a part of the supply chain.

At block 904, the method 900 includes acquiring a second data associated with a product amongst the plurality of products, where the second data includes a hierarchical information of the product, a historical path information of the product, and a historical inventory data associated with the product and the plurality of facilities. The second data including the hierarchical information of the product and the historical path information associated with the product may be similar to the information discussed above and has not been repeated for the sake of brevity. In one example, the historical inventory data associated with multiple products that are stored in the facility may be obtained.

At block 906, the method 900 includes generating a demand pattern in correspondence to the second data and the historical inventory data. In one example, demand patterns may be generated for various categories of demand, such as seasonal variations demand, product-based demand, location-based demand, and age-wise inventory demand across each facility amongst multiple facilities of the supply chain.

At block 908, the method 900 includes analyzing the demand patterns generated, along with the first data and the second data acquired form the product to generate feasible path layouts to transport the shipment mix from the first location to the second location.

At block 910, the method 900 includes selecting a recommended path from the feasible path layouts generated for transporting the shipment mix. In one example, the recommended path may be selected based on a particular category of demand, such as seasonal-based demand, product-based demand, aging inventory based-demand, location-based demand, and the like. Further, based on the demand based recommended path selected, the shipment mix may be modified to be able to meet the demand predicted.

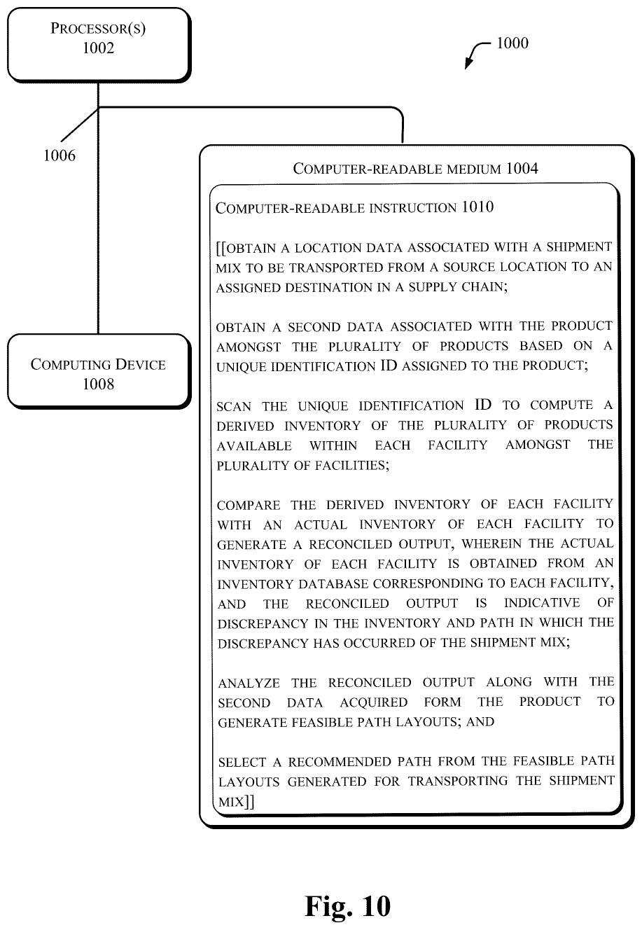

FIG. 10 illustrates a non-transitory computer-readable medium for logistics management of a supply chain, in accordance with an example of the present subject matter. In an example, the computing environment 1000 includes processor 1002 communicatively coupled to a non-transitory computer readable medium 1004 through communication link 1006. In an example implementation, the computing environment 1000 may be for example, the system for logistics management system 106. In an example, the processor 1002 may have one or more processing resources for fetching and executing computer-readable instructions from the non-transitory computer readable medium 1004. The processor 1002 and the non-transitory computer readable medium 1004 may be implemented, for example, in the system for logistics management.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, and the like. In an example implementation, the non-transitory computer readable medium 1004 includes a set of computer readable instructions 1010 which may be accessed by the processor 1002 through the communication link 1006 and subsequently executed for logistics management. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to obtain a location data associated with a shipment mix to be transported from a source location to an assigned destination in a supply chain, where the shipment mix includes a plurality of products.

The instructions 1010 may further cause the processor 1002 to obtain a second data associated with the product amongst the plurality of products based on a unique identifier ID assigned to the product. Further, the instructions 1010 may cause the processor 1002 scan the unique ID to compute a derived inventory of the plurality of products available within each facility amongst the plurality of facilities.

The instructions 1010 may further cause the processor 1002 to compare the derived inventory of each facility with an actual inventory of each facility to generate a reconciled output, where the actual inventory of each facility is obtained from an inventory database corresponding to each facility, and the reconciled output is indicative of discrepancy in the inventory and path in which the discrepancy has occurred of the shipment mix, analyze the reconciled output along with the second data acquired form the product to generate feasible path layouts, and select a recommended path from the feasible path layouts generated for transporting the shipment mix.

Although examples of the present subject matter have been described in language specific to methods and/or structural features, it is to be understood that the present subject matter is not limited to the specific methods or features described. Rather, the methods and specific features are disclosed and explained as examples of the present subject matter.

I/We claim:

1. A method for logistics management in a supply chain, the method comprising:
obtaining a first data comprising a first location and a second location associated with a shipment mix to be transported amongst a plurality of facilities located at different locations that form a part of the supply chain, wherein the shipment mix comprises a plurality of products;
acquiring a second data associated with a product amongst the plurality of products, wherein the second data includes a hierarchical information of the product and a historical path information of the product;
computing a derived inventory of the plurality of products available within each facility amongst the plurality of facilities based on the second data associated with the product;
comparing the derived inventory of each facility with an actual inventory of each facility to generate a reconciled output, wherein the actual inventory of each facility is obtained from an inventory database corresponding to each facility, and wherein the reconciled output is indicative of a discrepancy in the inventory and path in which the discrepancy has occurred of the shipment mix;
analyzing the reconciled output along with the second data acquired from the product to generate feasible path layouts; and
selecting a recommended path from the feasible path layouts generated for transporting the shipment mix.

2. The method as claimed in claim 1 further comprising determining a third location for the shipment mix being transported from the first location based on the recommended path.

3. The method as claimed in claim 1 further comprising modifying the shipment mix to be transported from the first location to the second location based on the recommended path.

4. The method as claimed in claim 1, wherein the hierarchical information is indicative of a case in which a unit of the product is packed into, an outer into which the case is packed into, and a pallet into which the outer is packed into.

5. The method as claimed in claim 1, wherein the historical path information is indicative of paths traveled by a similar shipment mix across various facilities of the supply chain historically.

6. The method as claimed in claim 1 further comprising determining a mode of transport for the shipment mix to be transported based on the recommended path.

7. The method as claimed in claim 1, wherein the reconciled output is further indicative of a time instant of the discrepancy.

8. The method as claimed in claim 1, wherein determining the feasible path layouts further comprises obtaining sensor data from a plurality of sensors associated with at least one of the shipment mix and a mode of transport of the shipment mix.

9. The method as claimed in claim 1, wherein the second data associated with the product includes an event data, wherein the event data is generated corresponding to an event and is associated with each facility and the product of a shipment mix, wherein the event may affect an initial status of the product in the shipment mix.

10. The method as claimed in claim 1, wherein the selecting the recommended path is based on a demand pattern associated with each facility and the product of the shipment mix.

11. The method as claimed in claim 1 further comprising modifying the shipment mix based on a demand pattern.

12. The method as claimed in claim 10, wherein the demand pattern is based on seasonal variations demand, product-based demand, and age-wise inventory demand, for each facility.

13. The method as claimed in claim 1, wherein the second data associated with the product amongst the plurality of products is an Electronic Product Code Information Services (EPCIS) data belonging to a global GS1 standard.

14. A system for logistics management, the system comprising:
an input module to
obtain a first data associated with a shipment mix to be transported from a first location to a second location amongst a plurality of facilities located at different locations that form a part of a supply chain, wherein the shipment mix comprises a plurality of products; and
acquire a second data associated with the product amongst the plurality of products, wherein the second data includes a hierarchical information of the product and a historical path information of the product;
an analyzing module to
compute a derived inventory of the plurality of products available within each facility amongst the plurality of facilities based on the second data associated with the product;
compare the derived inventory of each facility with an actual inventory of each facility to generate a reconciled output, the actual inventory of each facility is obtained from an inventory database corresponding to each facility, and wherein the reconciled output is indicative of a current status of the product; and
analyze the reconciled output along with the second data acquired associated with the product to generate feasible path layouts; and
a route optimizing module to
select a recommended path from the feasible path layouts generated for transporting the shipment mix in correspondence to the current status of the product.

15. The system as claimed in claim 14, wherein the analyzing module is to select the recommended path based on a demand pattern associated with each facility and the product of the shipment mix.

16. The system as claimed in claim 15, wherein the demand pattern is based on seasonal variations demand, product-based demand, and age-wise inventory demand across each facility amongst a plurality of facilities of the supply chain.

17. The system as claimed in claim 14, wherein the analyzing module is to determine a mode of transport for the shipment mix to be transported based on the recommended path.

18. The system as claimed in claim 14, wherein the analyzing module is to determine the feasible path layouts based on obtaining sensor data from a plurality of sensors associated with at least one of the shipment mix and a mode of transport of the shipment mix.

19. A non-transitory computer-readable medium comprising instructions for logistics management of a supply chain, the instructions being executable by a processor to:
obtain a location data associated with a shipment mix to be transported from a source location to an assigned destination in a supply chain, wherein the shipment mix comprises a plurality of products;
obtain a second data associated with the product amongst the plurality of products based on a unique identifier ID assigned to the product;
scan the unique ID to compute a derived inventory of the plurality of products available within each facility amongst a plurality of facilities;
compare the derived inventory of each facility with an actual inventory of each facility to generate a reconciled output, wherein the actual inventory of each facility is obtained from an inventory database corresponding to each facility, and the reconciled output is indicative of a discrepancy in the inventory and path in which the discrepancy has occurred of the shipment mix;
analyze the reconciled output along with the second data acquired form the product to generate feasible path layouts; and
select a recommended path from the feasible path layouts generated for transporting the shipment mix.

20. The non-transitory computer-readable medium as claimed in claim 19, wherein selecting the recommended path is based on a demand pattern associated with each facility and the product of the shipment mix.
